(19) United States
(12) Patent Application Publication
(10) Pub. No.: US 2022/0073094 A1
(43) Pub. Date: Mar. 10, 2022

(54) UNMANNED VEHICLE CONTROL SYSTEM AND UNMANNED VEHICLE CONTROL METHOD

(71) Applicant: Komatsu Ltd., Tokyo (JP)

(72) Inventors: Masanori Ogihara, Tokyo (JP); Ryuu Yamamura, Tokyo (JP)

(73) Assignee: Komatsu Ltd., Tokyo (JP)

(21) Appl. No.: 17/418,015

(22) PCT Filed: Nov. 21, 2019
(86) PCT No.: PCT/JP2019/045652

§ 371 Date: Jun. 24, 2021

(30) Foreign Application Priority Data
Jan. 17, 2019 (JP) 2019-006392

(51) Int. Cl. B60W 60/00; B60W 10/04; B60W 10/20

(52) U.S. Cl. CPC B60W 60/001; B60W 10/04; B60W 10/20; B60W 2300/17; B60W 2556/45; B60W 2710/207; B60W 2720/10; B60W 2720/12; B60W 2510/20

(57) ABSTRACT

An unmanned vehicle control system includes: a travel command unit that outputs a travel command for controlling a travel speed of an unmanned vehicle; a steering command unit that outputs a steering command for controlling a steering device of the unmanned vehicle; a response calculation unit that calculates a steering response of the steering device based on a target value of the steering device and a detected value of the steering device detected during a travel of the unmanned vehicle; a determination unit that determines whether the steering response satisfies a restrictive condition; and a restriction command unit that outputs a restriction command for restricting the travel speed when the steering response satisfies the restrictive condition.

### FIELD

The present disclosure relates to an unmanned vehicle control system and an unmanned vehicle control method.

### BACKGROUND

Unmanned vehicles are sometimes used at large-scale work sites such as mines. Travel courses for unmanned vehicles are set at the work site. An unmanned vehicle has a steering device. The steering device is controlled to allow the unmanned vehicle to travel according to the travel course.

### CITATION LIST

### Patent Literature

Patent Literature 1: JP 08-137549 A

### SUMMARY

### Technical Problem

Deterioration of the steering response of the steering device might lead to the deterioration of the follow-up performance of the unmanned vehicle traveling along the travel course.

### Solution to Problem

According to an aspect of the present invention, an unmanned vehicle control system comprises: a travel command unit that outputs a travel command for controlling a travel speed of an unmanned vehicle; a steering command unit that outputs a steering command for controlling a steering device of the unmanned vehicle; a response calculation unit that calculates a steering response of the steering device based on a target value of the steering device and a detected value of the steering device detected during a travel of the unmanned vehicle; a determination unit that determines whether the steering response satisfies a restrictive condition; and a restriction command unit that outputs a restriction command for restricting the travel speed when the steering response satisfies the restrictive condition.

### Advantageous Effects of Invention

According to an aspect of the present invention, it is possible to suppress deterioration in the follow-up performance of an unmanned vehicle traveling along a travel course.

### BRIEF DESCRIPTION OF DRAWINGS

FIG. 1 is a diagram schematically illustrating an example of an administration system and an unmanned vehicle according to an embodiment.

FIG. 2 is a diagram schematically illustrating an example of the unmanned vehicle according to the embodiment.

FIG. 3 is a diagram schematically illustrating an example of a work site according to the embodiment.

FIG. 4 is a functional block diagram illustrating an example of a management device and a control device according to the embodiment.

FIG. 5 is a diagram illustrating an example of a travel course according to the embodiment.

FIG. 6 is a flowchart illustrating an example of an unmanned vehicle control method according to the embodiment.

FIG. 7 is a block diagram illustrating an example of a computer system.

### DESCRIPTION OF EMBODIMENTS

Hereinafter, embodiments according to the present disclosure will be described with reference to the drawings, but the present disclosure is not limited to the embodiments. The constituents described in the embodiments below can be appropriately combine with each other. In some cases, a portion of the constituents is not utilized.

### Administration System

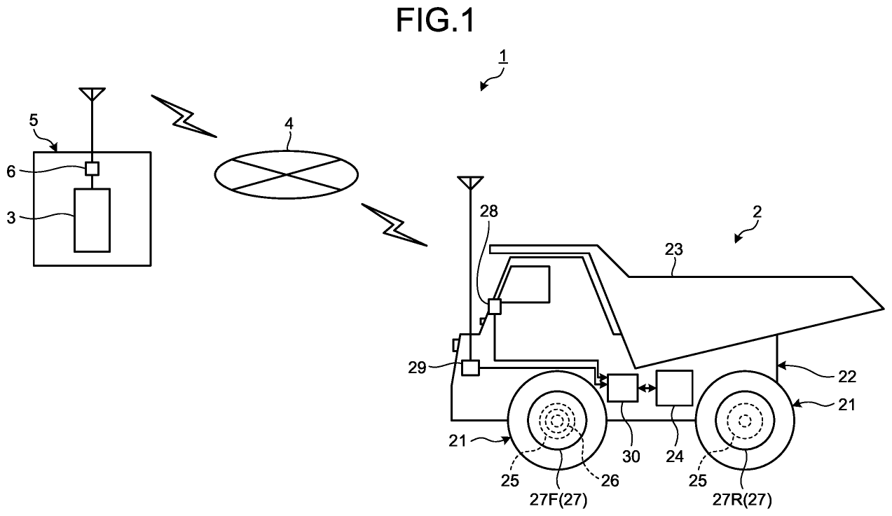

FIG. 1 is a diagram schematically illustrating an example of an administration system 1 and an unmanned vehicle 2 according to an embodiment. The unmanned vehicle 2 refers to a vehicle that performs unmanned travel without being driven by a driver. The unmanned vehicle 2 operates at work sites. The unmanned vehicle 2 is a dump truck which is a type of transportation vehicle that transports cargo while traveling in a work site.

The administration system 1 includes a management device 3 and a communication system 4. The management device 3 includes a computer system and is installed in, for example, an administration facility 5 in a mine. The communication system 4 performs communication between the management device 3 and the unmanned vehicle 2. The management device 3 is connected with a wireless communication device 6. The communication system 4 includes the wireless communication device 6. The management device 3 and the unmanned vehicle 2 wirelessly communicate with each other via the communication system 4. The unmanned vehicle 2 travels in the work site based on travel course data transmitted from the management device 3.

### Unmanned Vehicle

The unmanned vehicle 2 includes a traveling device 21, a vehicle main body 22 supported by the traveling device 21, a dump body 23 supported by the vehicle main body 22, and a control device 30.

The traveling device 21 includes a driving device 24 that generates a driving force, a braking device 25 that generates a braking force, a steering device 26 that adjusts the travel direction, and wheels 27.

The rotation of the wheels 27 allows autonomous travel of the unmanned vehicle 2. The wheels 27 include front wheels 27F and rear wheels 27R. The wheels 27 are equipped with tires.

The driving device 24 generates a driving force for accelerating the unmanned vehicle 2. The driving device 24 includes an internal combustion engine such as a diesel engine. The driving device 24 may include an electric motor. The power generated by the driving device 24 is transmitted to the rear wheels 27R. The braking device 25 generates a braking force for decelerating or stopping the unmanned vehicle 2. The steering device 26 can adjust the travel direction of the unmanned vehicle 2. The travel direction of the unmanned vehicle 2 includes the direction of the front portion of the vehicle main body 22. By steering the front wheels 27F, the steering device 26 adjusts the travel direction of the unmanned vehicle 2.

The control device 30 outputs a travel command for controlling one or both of the driving device 24 and the braking device 25, and a steering command for controlling the steering device 26. The travel command includes an accelerator command for controlling the driving device 24 and a brake command for controlling the braking device 25. The driving device 24 generates a driving force for accelerating the unmanned vehicle 2 based on the accelerator command output from the control device 30. The braking device 25 generates a braking force for decelerating the unmanned vehicle 2 based on the brake command output from the control device 30. By controlling one or both of the driving device 24 and the braking device 25, the travel speed of the unmanned vehicle 2 is adjusted. Based on the steering command output from the control device 30, the steering device 26 generates a steering force for changing the direction of the front wheels 27F in order to allow the unmanned vehicle 2 to travel straight or turn.

Furthermore, the unmanned vehicle 2 includes a position detection device 28 that detects the position of the unmanned vehicle 2. The position of the unmanned vehicle 2 is detected using a global navigation satellite system (GNSS). The global navigation satellite systems include the Global Positioning System (GPS). The global navigation satellite system detects the absolute position of the unmanned vehicle 2 defined by coordinate data of latitude, longitude, and altitude. The global navigation satellite system detects the position of the unmanned vehicle 2 as defined in a global coordinate system. The global coordinate system is a coordinate system fixed to the earth. The position detection device 28 includes a GNSS receiver and detects the absolute position (coordinates) of the unmanned vehicle 2.

Furthermore, the unmanned vehicle 2 includes a wireless communication device 29. The communication system 4 includes the wireless communication device 29. The wireless communication device 29 can wirelessly communicate with the management device 3.

### Hydraulic System

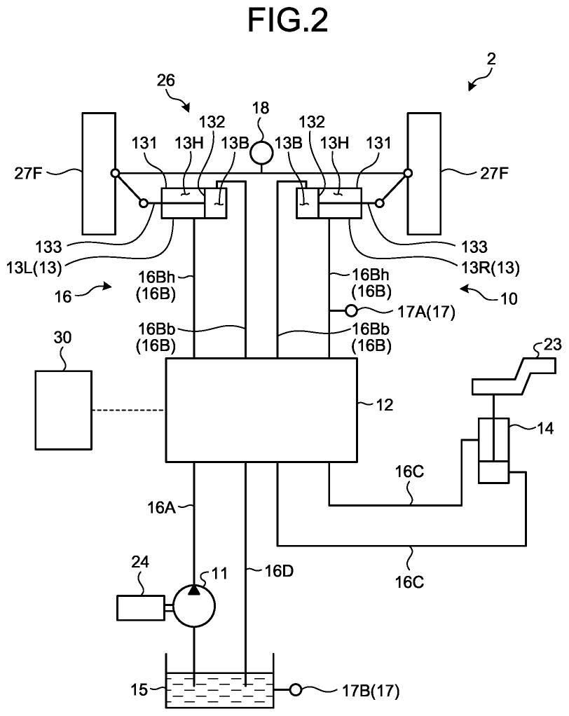

FIG. 2 is a diagram schematically illustrating an example of the unmanned vehicle 2 according to the embodiment of the present disclosure. As illustrated in FIG. 2, the unmanned vehicle 2 includes a hydraulic system 10.

The hydraulic system 10 includes a hydraulic pump 11 that operates on a driving force generated by the driving device 24, a valve device 12 connected to the hydraulic pump 11 via a flow path, a first hydraulic actuator 13 that is driven based on the hydraulic oil supplied from the hydraulic pump 11, a second hydraulic actuator 14 that is driven based on the hydraulic oil supplied from the hydraulic pump 11, and a hydraulic oil tank 15 that stores hydraulic oil.

The driving device 24 is a power source for the hydraulic pump 11. The hydraulic pump 11 is a power source for the first hydraulic actuator 13 and a power source for the second hydraulic actuator 14. The hydraulic pump 11 is connected to an output shaft of the driving device 24 and operates on the driving force generated by the driving device 24. The hydraulic pump 11 sucks the hydraulic oil contained in the hydraulic oil tank 15 and discharges the hydraulic oil from a discharge port.

The first hydraulic actuator 13 allows the steering device 26 to operate. The steering device 26 operates on the power generated by the first hydraulic actuator 13. The first hydraulic actuator 13 is a hydraulic cylinder. The first hydraulic actuator 13 expands and contracts based on the flow rate of the hydraulic oil. With expansion and contraction of the first hydraulic actuator 13, the steering device 26 coupled to the first hydraulic actuator 13 operates.

The hydraulic oil discharged from the hydraulic pump 11 is supplied to the first hydraulic actuator 13 via a flow path 16A, the valve device 12, and a flow path 16B. The hydraulic oil flowing out of the first hydraulic actuator 13 is returned to the hydraulic oil tank 15 via the flow path 16B, the valve device 12, and a flow path 16D.

In the following description, the first hydraulic actuator 13 is appropriately referred to as a steering cylinder 13.

The steering cylinder 13 includes a cylinder tube 131 having a bottom, a piston 132 that divides an internal space of the cylinder tube 131 into a bottom chamber 13B and a head chamber 13H, and a rod 133 coupled to the piston 132. The flow path 16B includes a flow path 16Bb connected to the bottom chamber 13B and a flow path 16Bh connected to the head chamber 13H.

The hydraulic oil discharged from the hydraulic pump 11 is supplied to the bottom chamber 13B via the flow path 16A, the valve device 12, and the flow path 16Bb. When the hydraulic oil is supplied to the bottom chamber 13B, the steering cylinder 13 extends.

Furthermore, the hydraulic oil discharged from the hydraulic pump 11 is supplied to the head chamber 13H via the flow path 16A, the valve device 12, and the flow path 16Bh. When the hydraulic oil is supplied to the head chamber 13H, the steering cylinder 13 contracts.

The front wheel 27F on the left side and the front wheel 27F on the right side are coupled to each other via a link mechanism. In the embodiment, the steering cylinder 13 includes a steering cylinder 13L and a steering cylinder 13R. By the operation of the steering cylinder 13L and the steering cylinder 13R, the left front wheel 27F and the right front wheel 27F, which are coupled to each other via the link mechanism, operate in synchronization with each other. The number of steering cylinders 13 may be one.

The second hydraulic actuator 14 allows the dump body 23 to operate. The dump body 23 operates on the power generated by the second hydraulic actuator 14. The second hydraulic actuator 14 is a hydraulic cylinder. The second hydraulic actuator 14 expands and contracts based on the hydraulic oil. With the expansion and contraction of the second hydraulic actuator 14, the dump body 23 coupled to the second hydraulic actuator 14 moves in an up-down direction.

The hydraulic oil discharged from the hydraulic pump 11 is supplied to the second hydraulic actuator 14 via the flow path 16A, the valve device 12, and a flow path 16C. The hydraulic oil flowing out from the second hydraulic actuator 14 is returned to the hydraulic oil tank 15 via the flow path 16C, the valve device 12, and the flow path 16D.

In the following description, the second hydraulic actuator 14 is appropriately referred to as a hoist cylinder 14.

The valve device 12 operates based on an operation command from the control device 30. The valve device 12 can adjust the circulating state of the hydraulic oil in a hydraulic circuit 16 connected to each of the steering cylinder 13 and the hoist cylinder 14. The valve device 12 includes: a first flow rate adjusting valve capable of adjusting the flow rate and direction of the hydraulic oil supplied to the steering cylinder 13; and a second flow rate adjusting valve capable of adjusting the flow rate and direction of the hydraulic oil supplied to the hoist cylinder 14.

Furthermore, the hydraulic circuit 16 includes a temperature sensor 17 that detects the temperature of the hydraulic oil supplied to the steering cylinder 13. The temperature sensor 17 includes: a temperature sensor 17A that detects the temperature of the hydraulic oil in the flow path 16B connected to the steering cylinder 13; and a temperature sensor 17B that detects the temperature of the hydraulic oil in the hydraulic oil tank 15.

Furthermore, the steering device 26 includes a steering angle sensor 18 that detects the steering angle of the steering device 26. The steering angle sensor 18 includes a potentiometer, for example.

### Work Site

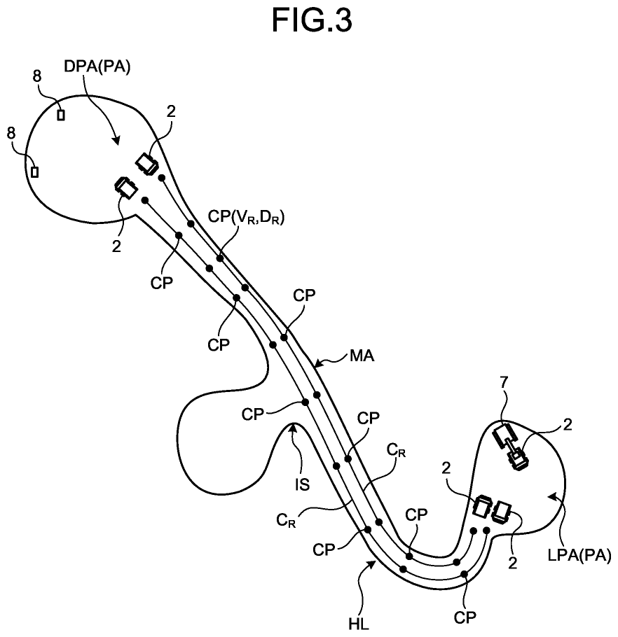

FIG. 3 is a diagram schematically illustrating an example of a work site according to the embodiment. In the embodiment, the work site is a mine or quarry. A mine is a place where minerals are mined or an office concerning the mining. A quarry is a place where rocks are mined or an office concerning the mining. Examples of the cargo carried on the unmanned vehicle 2 include ore, or earth and sand, excavated in a mine or a quarry.

The unmanned vehicle 2 travels at least in a part of a work place PA and a travel path HL leading to the work place PA. The work place PA includes at least one of a loading area LPA and a dumping area DPA. The travel path HL includes an intersection IS.

The loading area LPA refers to an area for performing a loading work for loading the unmanned vehicle 2 with cargo. At the loading area LPA, a loading machine 7 such as an excavator operates. The dumping area DPA refers to an area for performing a discharge work of discharging the cargo from the unmanned vehicle 2. For example, a crusher 8 is installed in the dumping area DPA.

In the following description, an area where the unmanned vehicle 2 can travel in the work site, such as the travel path HL and the work place PA, is appropriately referred to as a travel area MA.

The unmanned vehicle 2 travels in the travel area MA based on travel course data indicating the travel conditions of the unmanned vehicle 2. As illustrated in FIG. 3, the travel course data includes a plurality of course points CP set at intervals. The course point CP defines a target position of the unmanned vehicle 2 in the travel area MA. A target travel speed V_{R} and a target travel direction D_{R} of the unmanned vehicle 2 are set in each of the plurality of course points CP. In addition, the travel course data includes a travel course C_{R} set in the travel area MA. The travel course C_{R} indicates a target travel route of the unmanned vehicle 2. The travel course C_{R} is defined by a line connecting the plurality of course points CP.

The travel course data is generated in the management device 3. The management device 3 transmits the generated travel course data to the control device 30 of the unmanned vehicle 2 via the communication system 4. Based on the travel course data, the control device 30 controls the traveling device 21 so that the unmanned vehicle 2 will travel according to the travel course C_{R} and travel according to the target travel speed V_{R} and the target travel direction D_{R} set for each of the plurality of course points CP.

### Management Device and Control Device

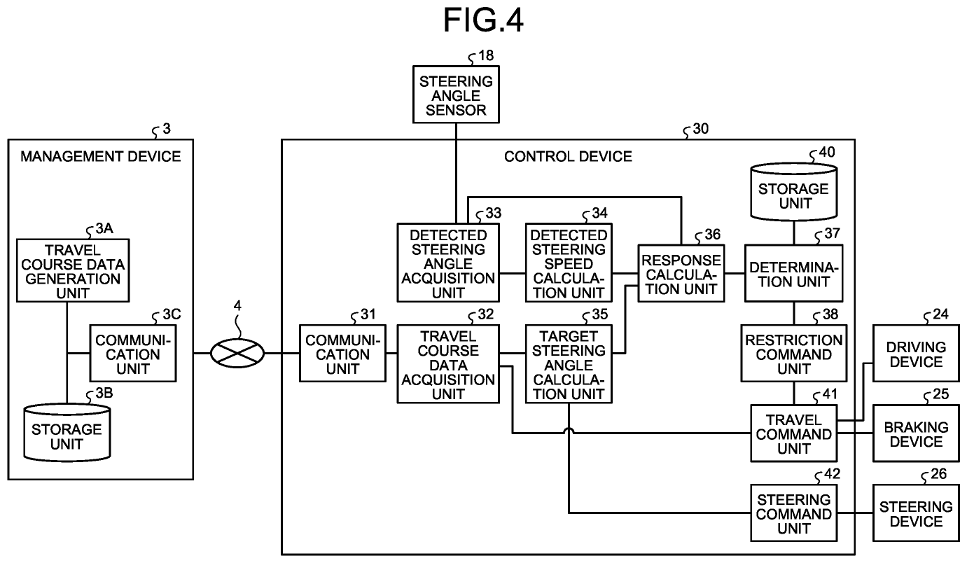

FIG. 4 is a functional block diagram illustrating an example of the management device 3 and the control device 30 according to the embodiment. The control device 30 can communicate with the management device 3 via the communication system 4.

The management device 3 includes a travel course data generation unit 3A that generates travel course data, a storage unit 3B, and a communication unit 3C.

The travel course data generation unit 3A generates travel course data including the travel course C_{R} of the unmanned vehicle 2. The storage unit 3B stores a program required for generating the travel course data in the travel course data generation unit 3A. The travel course data generation unit 3A outputs the generated travel course data to the communication unit 3C. The communication unit 3C transmits the travel course data to the control device 30 of the unmanned vehicle 2.

The control device 30 includes a communication unit 31, a travel course data acquisition unit 32, a detected steering angle acquisition unit 33, a detected steering speed calculation unit 34, a target steering angle calculation unit 35, a response calculation unit 36, a determination unit 37, a restriction command unit 38, a travel command unit 41, a steering command unit 42, and a storage unit 40.

The travel course data acquisition unit 32 acquires the travel course data transmitted from the management device 3 via the communication unit 31. As described above, the travel course data includes the travel course C_{R}, the target travel speed V_{R} of the unmanned vehicle 2, and the target travel direction D_{R} of the unmanned vehicle 2.

The detected steering angle acquisition unit 33 acquires a detected steering angle δ_{S} indicating a steering angle δ of the steering device 26 detected by the steering angle sensor 18. The detected steering angle δ_{S} indicates detected data from the steering angle sensor 18.

The detected steering speed calculation unit 34 calculates a detected steering speed γ_{S} of the steering device 26 based on the detected steering angle δ_{S}. The detected steering speed calculation unit 34 calculates the detected steering speed γ_{S} by differentiating the detected data from the steering angle sensor 18.

The target steering angle calculation unit 35 calculates a target steering angle δ_{R} based on the target travel direction D_{R} of the unmanned vehicle 2 defined by the travel course data and on the amount of deviation between the travel course C_{R} and an actual travel track C_{S} of the unmanned vehicle 2.

The response calculation unit 36 calculates a steering response of the steering device 26 based on a target value of the steering device 26 and a detected value of the steering device 26 detected during the travel of the unmanned vehicle 2. The target value of the steering device 26 includes at least one of the target steering angle δ_{R} or a target steering speed γ_{R}. The detected value of the steering device 26 includes at least one of the detected steering angle δ_{S} and the detected steering speed γ_{S}. In the embodiment, the response calculation unit 36 calculates the steering response of the steering device 26 based on the target steering angle δ_{R} of the steering device 26 calculated by the target steering angle calculation unit 35 and on the detected steering angle δ_{S} of the steering device 26 detected during the travel of the unmanned vehicle 2.

The steering response of the steering device 26 includes a difference Δδ between the target steering angle δ_{R} and the detected steering angle δ_{S}. Furthermore, the steering response of the steering device 26 includes the detected steering speed γ_{S} of the steering device 26 detected during the travel of the unmanned vehicle 2. The steering response of the steering device 26 may be either the difference Δδ or the detected steering speed γ_{S}. Still, it is preferable that the steering response of the steering device 26 includes both the difference Δδ and the detected steering speed γ_{S}.

The determination unit 37 determines whether the steering response calculated by the response calculation unit 36 satisfies a restrictive condition.

In the embodiment, the restrictive condition includes one or both of conditions, namely, a condition that the difference Δδ between the target steering angle δ_{R} and the detected steering angle δ_{S} is a first threshold δ₁ or more, and a condition that the detected steering speed γ_{S} of the steering device 26 detected during the travel of the unmanned vehicle 2 is a second threshold δ₂ or less. The restrictive conditions including the first threshold δ₁ and the second threshold δ₂ are predetermined and stored in the storage unit 40.

When the determination unit 37 has determined that the steering response satisfies the restrictive condition, the restriction command unit 38 outputs a restriction command of restricting a travel speed V_{S} of the unmanned vehicle 2.

The travel command unit 41 outputs a travel command for controlling the travel speed V_{S} of the unmanned vehicle 2. The travel command includes an accelerator command for controlling the driving device 24 and a brake command for controlling the braking device 25. The travel speed V_{S} of the unmanned vehicle 2 is controlled by outputting the accelerator command to the driving device 24 and the brake command to the braking device 25.

When the restriction command unit 38 has not output the restriction command, the travel command unit 41 outputs a travel command based on the target travel speed V_{R} of the unmanned vehicle 2 defined by the travel course data. That is, when the restriction command unit 38 has not output the restriction command, the travel command unit 41 outputs the travel command so that the travel speed V_{S} of the unmanned vehicle 2 becomes the target travel speed V_{R}.

When the restriction command unit 38 has output the restriction command, the travel command unit 41 outputs a travel command so that the travel speed V_{S} of the unmanned vehicle 2 becomes a restricted travel speed V_{L} lower than the target travel speed V_{R}.

When the restriction command has been output from the restriction command unit 38, the travel command unit 41 outputs a travel command so as to decelerate from the target travel speed V_{R} to the restricted travel speed V_{L} at a constant deceleration.

Furthermore, the determination unit 37 determines whether the steering response calculated by the response calculation unit 36 satisfies a cancel condition.

The cancel condition includes a condition that the difference Δδ between the target steering angle δ_{R} and the detected steering angle δ_{S} is less than the first threshold δ₁. The cancel condition including the first threshold δ₁ is predetermined and is stored in the storage unit 40. The cancel condition may be defined based on the first threshold δ₁ or may be defined based on a third threshold δ_{S} different from the first threshold δ₁.

The restriction command unit 38 cancels the restriction command when the determination unit 37 has determined that the steering response satisfies the cancel condition.

When the restriction command is canceled, the travel command unit 41 outputs a travel command so that the travel speed V_{S} of the unmanned vehicle 2 becomes the target travel speed V_{R}.

When the restriction command is canceled, the travel command unit 41 outputs a travel command so as to accelerate from the restricted travel speed V_{L} to the target travel speed V_{R} at a constant acceleration.

The steering command unit 42 outputs a steering command for controlling the steering device 26 of the unmanned vehicle 2. The steering command unit 42 outputs a steering command based on the target travel direction D_{R} of the unmanned vehicle 2 defined by the travel course data and on the amount of deviation between the travel course C_{R} and the actual travel track C_{S} of the unmanned vehicle 2. In the embodiment, the steering command unit 42 outputs a steering command so that the steering device 26 becomes the target steering angle δ_{R}.

As described above, operation of the steering device 26 is performed by the steering cylinder 13. The operation speed (cylinder speed) of the steering cylinder 13 is adjusted by the flow rate of hydraulic oil supplied to the steering cylinder 13. The valve device 12 has a first flow rate adjusting valve that adjusts the flow rate of the hydraulic oil supplied to the steering cylinder 13. The steering command unit 42 supplies current to the first flow rate adjusting valve as a steering command. When turning the unmanned vehicle 2, the steering command unit 42 outputs a steering command (current) at the maximum value to the first flow rate adjusting valve so that the steering device 26 operates at a maximum steering speed γ_{MAX}. That is, when turning the unmanned vehicle 2, the steering command unit 42 fully opens the first flow rate adjusting valve to adjust the flow rate of the hydraulic oil supplied to the steering cylinder 13 so that the steering device 26 operates at the maximum steering speed γ_{MAX}.

The response calculation unit 36 calculates the steering response based on the target steering angle δ_{R} and the detected steering angle δ_{S} when the steering command is output from the steering command unit 42 at the maximum value. That is, the response calculation unit 36 calculates the difference Δδ between the target steering angle δ_{R} and the detected steering angle δ_{S} when the steering command is output so that the steering device 26 operates at the maximum steering speed γ_{MAX}.

### Travel Course

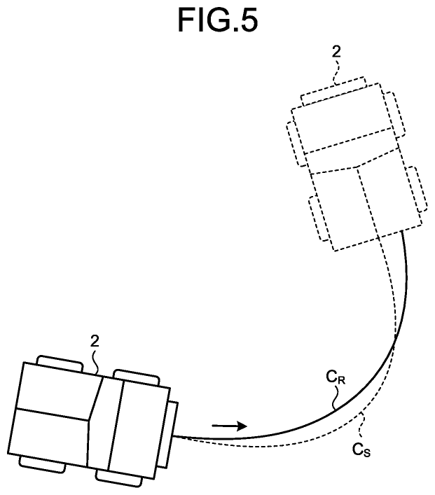

FIG. 5 is a diagram illustrating an example of the travel course C_{R} according to the embodiment. As illustrated in FIG. 5, the unmanned vehicle 2 is controlled to travel according to the travel course C_{R}. When the steering response of the steering device 26 deteriorates, as illustrated in FIG. 5, the actual travel track C_{S} of the unmanned vehicle 2 deviates from the travel course C_{R}.

When the amount of deviation between the travel course C_{R} and the actual travel track C_{S} becomes a set value or more, the travel of the unmanned vehicle 2 needs to be stopped. This might result in deterioration of the productivity at the work site.

There is a possibility that a time lag occurs during the time from the output of a steering command from the steering command unit 42 to the steering device 26 (valve device 12) in order to set the steering device 26 to the target steering angle δ_{R} until the time at which the actual steering angle δ (detected steering angle δ_{S}) of the steering device 26 reaches the target steering angle δ_{R}. The poor steering response would lead to a large difference Δδ between the target steering angle δ_{R} and the detected steering angle δ_{S} at the time when the steering command is output to set the steering device 26 to the target steering angle δ_{R}.

Furthermore, as described above, the steering command unit 42 outputs the steering command at the maximum value so that the steering device 26 operates at the maximum steering speed γ_{MAX} when turning the unmanned vehicle 2. When the steering response is poor, the actual steering speed γ (detected steering speed γ_{S}) becomes a value smaller than the maximum steering speed γ_{MAX} even though the steering command is output at the maximum value.

Therefore, in the embodiment, the response calculation unit 36 calculates, as the steering response of the steering device 26, the difference Δδ between the target steering angle δ_{R} and the detected steering angle δ_{S} as well as the detected steering speed γ_{S} of the steering device 26 detected during the travel of the unmanned vehicle 2.

One example of deterioration in the steering response would be a road surface condition. An uneven or muddy road surface leads to deterioration of the steering response.

Furthermore, as one example of causes of the deterioration of the steering response is a lowered temperature of the hydraulic oil that allows operation of the steering cylinder 13. With a lowered temperature of the hydraulic oil and a higher viscosity of the hydraulic oil, it would take time until the actual steering angle δ (detected steering angle δ_{S}) of the steering device 26 becomes the target steering angle δ_{R} or the actual steering speed γ (detected steering speed γ_{S}) of the steering device 26 is insufficient even when the steering command is output to the valve device 12 at the maximum value, leading to the deterioration of the steering response.

Furthermore, the shape of the travel course C_{R} is one example of the causes of deterioration in steering response. For example, the deterioration of the steering response is caused by a large curvature of the curve of the travel course C_{R}.

When the unmanned vehicle 2 turns at the target travel speed V_{R} in spite of the low steering response, the actual travel track C_{S} of the unmanned vehicle 2 is likely to deviate from the travel course C_{R} as illustrated in FIG. 5. The target travel speed V_{R} is set assuming a state in which the steering response is good in order to suppress a deterioration of productivity at the work site. That is, the target travel speed V_{R} is set to the highest possible travel speed. Therefore, when the steering response is low, the unmanned vehicle 2 traveling at the target travel speed V_{R} is likely to deviate from the travel course C_{R}.

To handle this, when the steering response satisfies a restrictive condition when the unmanned vehicle 2 turns, the travel command unit 41 controls the unmanned vehicle 2 to travel at the restricted travel speed V_{L} lower than the target travel speed V_{R} based on the restriction command output from the restriction command unit 38. With this control, the unmanned vehicle 2 can travel according to the travel course C_{R} even when the steering response of the steering device 26 is low. When the steering response does not satisfy the restrictive condition or the steering response satisfies the cancel condition, the travel command unit 41 controls the unmanned vehicle 2 to travel at the target travel speed V_{R}. Since the steering device 26 has high steering response, the unmanned vehicle 2 can travel according to the travel course C_{R}.

### Control Method

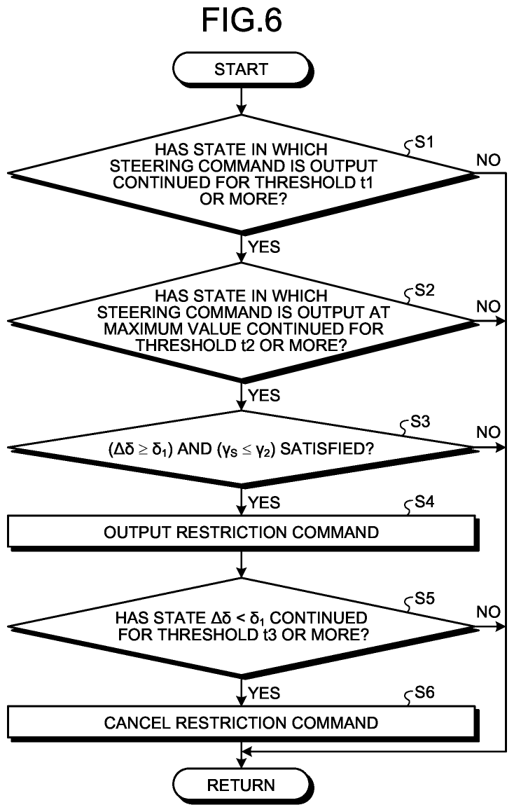

FIG. 6 is a flowchart illustrating an example of a method of controlling the unmanned vehicle 2 according to the embodiment. In the management device 3, the travel course data generation unit 3A generates travel course data. The travel course data generated by the travel course data generation unit 3A is transmitted to the control device 30 via the communication system 4. The travel course data acquisition unit 32 acquires the travel course data. The travel command unit 41 controls the unmanned vehicle 2 to travel based on the travel course data. The unmanned vehicle 2 travels at the target travel speed V_{R} based on the travel course data.

When the travel course C_{R} has a curve, the target steering angle calculation unit 35 calculates the target steering angle δ_{R} based on the target travel direction D_{R}. The steering command unit 42 outputs a steering command to the steering device 26 (valve device 12) in consideration of the amount of deviation between the travel course C_{R} and the actual travel track C_{S} of the unmanned vehicle 2 so that the steering device 26 becomes the target steering angle δ_{R}. The detected steering angle acquisition unit 33 acquires, from the steering angle sensor 18, the detected steering angle δ_{S} when the steering command is output. The detected steering speed calculation unit 34 calculates the detected steering speed γ_{S} based on the detected steering angle δ_{S}.

The response calculation unit 36 calculates the steering response of the steering device 26 based on the target steering angle δ_{R} of the steering device 26 and on the detected steering angle δ_{S} detected during the travel of the unmanned vehicle 2. The response calculation unit 36 calculates the difference Δδ between the target steering angle δ_{R} and the detected steering angle δ_{S}, as the steering response. Furthermore, the response calculation unit 36 acquires the detected steering speed γ_{S} from the detected steering speed calculation unit 34, as the steering response.

The response calculation unit 36 determines whether the state in which the steering command is output from the steering command unit 42 continues for a threshold t1 [seconds] or more (step S1).

There is a possibility that the hydraulic pressure acting on the steering cylinder 13 is insufficient immediately after the output of the steering command from the steering command unit 42. That is, immediately after the output of the steering command from the steering command unit 42, it might be difficult to accurately calculate the steering response due to the delayed response in the hydraulic pressure. In the embodiment, in consideration of the delayed response in the hydraulic pressure, a determination is made as to whether the state in which the steering command is output from the steering command unit 42 has continued for the threshold t1 or more. By calculating the steering response after the determination of the state in which the steering command is output from the steering command unit 42 has continued for the threshold t1 or more, it is possible to accurately calculate the steering response in which the influence of the hydraulic response delay is suppressed. Note that the threshold t1 is a value set in advance based on a preliminary experiment, a simulation experiment, or the like.

When it is determined in step S1 that the state in which the steering command is output has not continued for the threshold t1 [seconds] or more (step S1: No), the process returns to step S1.

When it is determined in step S1 that the state in which the steering command is output has continued for the threshold t1 [seconds] or more (step S1: Yes), the response calculation unit 36 determines whether the state in which the steering command is output at the maximum value has continued for a threshold t2 [seconds] or more (step S2).

When it is determined in step S2 that the state in which the steering command is output at the maximum value has not continued for the threshold t2 [seconds] or more (step S2: No), the process returns to step S1.

When it is determined in step S2 that the state in which the steering command is output at the maximum value has continued for the threshold t2 [seconds] or more (step S2: Yes), the determination unit 37 determines whether the steering response of the steering device 26 satisfies a restrictive condition. The determination unit 37 determines whether the conditions, namely, a condition that the difference Δδ between the target steering angle δ_{R} and the detected steering angle δ_{S} is the first threshold δ₁ or more (Δδ≥δ₁), and a condition that the detected steering speed γ_{S} of the steering device 26 detected during the travel of the unmanned vehicle 2 is the second threshold γ₂ or less (γ_{S}≤γ₂), are satisfied (step S3).

When it is determined in step S3 that the steering response does not satisfy the restrictive condition (step S3: No), the process returns to step S1.

When it is determined in step S3 that the steering response satisfies the restrictive condition, that is, when it is determined that the both conditions [Δδ≥δ₁] and [γ_{S}≤γ₂] are satisfied (step S3: Yes), the restriction command unit 38 outputs a restriction command of restricting the travel speed V_{S} of the unmanned vehicle 2 to the travel command unit 41 (step S4).

In a case where the restriction command unit 38 has output the restriction command, the travel command unit 41 outputs a travel command to set the travel speed V_{S} of the unmanned vehicle 2 to the restricted travel speed V_{L} lower than the target travel speed V_{R}. The travel command unit 41 outputs a travel command so as to decelerate from the target travel speed V_{R} to the restricted travel speed V_{L} at a constant deceleration. This allows the unmanned vehicle 2 to travel at the restricted travel speed V_{L}. The unmanned vehicle 2 turns the curve of the travel course C_{R} at the restricted travel speed V_{L} lower than the target travel speed V_{R} even in a situation where the steering response of the steering device 26 satisfies the restrictive condition, that is, in a situation where the steering response of the steering device 26 is low, making it possible to suppress the deviation of the vehicle from the travel course C_{R}.

When the unmanned vehicle 2 decelerates to the restricted travel speed V_{L}, warning data is displayed on a display device provided in the administration facility 5. By viewing the display device, an administrator present in the administration facility 5 can recognize that the unmanned vehicle 2 is decelerating to the restricted travel speed V_{L}. As described above, one example of deterioration in the steering response would be the road surface condition. Based on the warning data displayed on the display device, the administrator can notify a manned vehicle or an operator of a repair instruction of the travel path HL so as to improve the road surface condition. By improving the road surface condition, the unmanned vehicle 2 would not have to decelerate, making it possible to suppress the deterioration of productivity at the work site.

Furthermore, as described above, the shape of the travel course C_{R} is one example of the causes of deterioration of the steering response. For example, the deterioration of the steering response is caused by a large curvature of the curve of the travel course C_{R}. By adjusting the travel course data so as to decrease the curvature of the curve of the travel course C_{R}, the unmanned vehicle 2 would not have to decelerate, making it possible to suppress the deterioration of productivity at the work site.

The determination unit 37 determines whether the steering response of the steering device 26 satisfies a cancel condition. In the present disclosure, the determination unit 37 determines whether the condition that the difference Δδ between the target steering angle δ_{R} and the detected steering angle δ_{S} is less than the first threshold δ₁ (that is, Δδ<δ₁) has continued for a threshold t3 [seconds] or more (step S5).

When it is determined in step S5 that the steering response does not satisfy the cancel condition (step S5: No), the process returns to step S1.

In step S5, when it is determined that the steering response satisfies the cancel condition, that is, when it is determined that the condition [Δδ<δ₁] is satisfied (step S5: Yes), the restriction command unit 38 cancels the restriction command of restricting the travel speed V_{S} of the unmanned vehicle 2 (step S6).

When the restriction command has been output, the travel command unit 41 outputs a travel command so that the travel speed V_{S} of the unmanned vehicle 2 becomes the target travel speed V_{R}. The travel command unit 41 outputs a travel command so as to accelerate from the restricted travel speed V_{L} to the target travel speed V_{R} at a constant acceleration. This allows the unmanned vehicle 2 to travel at the target travel speed V_{R}. For example, when the unmanned vehicle 2 finishes turning the curve of the travel course C_{R} and travels according to the travel course C_{R}, which is linear, the unmanned vehicle 2 travels at the target travel speed V_{R} higher than the restricted travel speed V_{L}, making it possible to suppress the deterioration of productivity at the work site.

### Effects

As described above, according to the present disclosure, when the steering response of the steering device 26 is low, the travel speed V_{S} of the unmanned vehicle 2 is restricted. This makes it possible to suppress the deviation of the unmanned vehicle 2 from the travel course C_{R}.

The steering response is calculated based on the detected value of the steering device 26 detected by the steering angle sensor 18. Since the steering response is calculated based on the detected value of the steering angle sensor 18 without going through the administration facility 5, for example, it is possible to reduce the time lag from the end of calculation of the steering response to the restriction of the travel speed V_{S} of the unmanned vehicle 2. That is, it is possible to execute the process of calculating the steering response and the process of restricting the travel speed V_{S} of the unmanned vehicle 2 in a short time. Accordingly, it is possible to decrease the travel speed V_{S} of the unmanned vehicle 2 before the unmanned vehicle 2 deviates from the travel course C_{R}.

When the restriction command is not output, the unmanned vehicle 2 travels based on the target travel speed V_{R} defined by the travel course data. When the restriction command is output, the unmanned vehicle 2 travels at the restricted travel speed V_{L} lower than the target travel speed V_{R}. This makes it possible to suppress the deviation of the unmanned vehicle 2 from the travel course C_{R}.

When the restriction command is output, the unmanned vehicle 2 decelerates from the target travel speed V_{R} to the restricted travel speed V_{L} at a constant deceleration. This makes it possible to suppress sudden deceleration of the unmanned vehicle 2.

The steering command unit 42 outputs the steering command at the maximum value so that the steering device 26 operates at the maximum steering speed γ_{MAX} when turning the unmanned vehicle 2. In the present disclosure, the response calculation unit 36 calculates the steering response based on the target steering angle δ_{R} and the detected steering angle δ_{S} when the steering command is output from the steering command unit 42 at the maximum value. When the steering command is output from the steering command unit 42 at the maximum value, the restriction command unit 38 outputs the restriction command of restricting the travel speed V_{S} of the unmanned vehicle 2 in order to suppress the deviation of the unmanned vehicle 2 from the travel course C_{R}. For example, when the steering device 26 is not operating at the maximum steering speed γ_{MAX}, there is a possibility of enabling suppression of the deviation of the unmanned vehicle 2 from the travel course C_{R} by controlling the steering device 26 without restricting the travel speed V_{S} of the unmanned vehicle 2. In the present disclosure, by restricting the travel speed V_{S} of the unmanned vehicle 2 in a state where the steering command is output at the maximum value so that the steering device 26 operates at the maximum steering speed γ_{MAX}, it is possible to effectively suppress the deviation of the unmanned vehicle 2 from the travel course C_{R}.

### Computer System

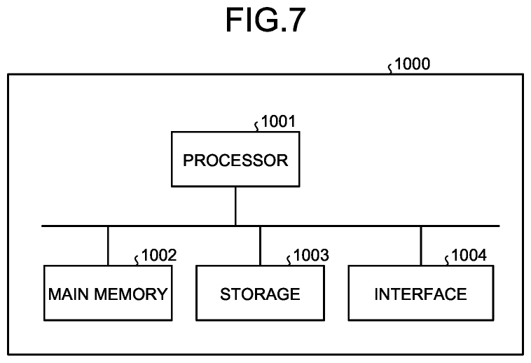

FIG. 7 is a block diagram illustrating an example of a computer system 1000. The management device 3 and the control device 30 described above each include the computer system 1000. The computer system 1000 includes: a processor 1001 including a processor such as a central processing unit (CPU); main memory 1002 including non-volatile memory such as read only memory (ROM) and volatile memory such as random access memory (RAM); storage 1003; and an interface 1004 including an input/output circuit. The function of the management device 3 and the function of the control device 30 described above are stored as a program in the storage 1003. The processor 1001 reads the program from the storage 1003, expands the program to the main memory 1002, and executes the above-described processes according to the program. The program may be delivered to the computer system 1000 via a network.

According to the above-described embodiment, the computer system 1000 can execute: calculation of the steering response of the steering device 26 based on the target value of the steering device 26 of the unmanned vehicle 2 and the detected value of the steering device 26 detected during the travel of the unmanned vehicle 2; and restriction of the travel speed V_{S} of the unmanned vehicle 2 when the steering response satisfies the restrictive condition.

### Other Embodiments

In the above-described embodiment, the steering response of the steering device 26 is calculated based on the target steering angle δ_{R} and the detected steering angle δ_{S}. The steering response of the steering device 26 may be calculated based on the target steering speed γ_{R} and the detected steering speed γ_{S}. For example, the steering response of the steering device 26 may be calculated based on a difference Δγ between the target steering speed γ_{R} and the detected steering speed γ_{S}.

Note that, in the above-described embodiment, at least a part of the functions of the control device 30 of the unmanned vehicle 2 may be provided in the management device 3, or at least a part of the functions of the management device 3 may be provided in the control device 30.

In the above-described embodiment, the travel course data is generated in the management device 3, and the unmanned vehicle 2 travels according to the travel course data transmitted from the management device 3. The control device 30 of the unmanned vehicle 2 may generate the travel course data. That is, the control device 30 may include a travel course data generation unit. Furthermore, the management device 3 and the control device 30 may individually include a travel course data generation unit.

In the above-described embodiment, the unmanned vehicle 2 is to travel based on the travel course data.

The unmanned vehicle 2 may travel by remote control or may travel autonomously.

In the above-described embodiment, the unmanned vehicle 2 is a dump truck which is a type of transportation vehicle. The unmanned vehicle 2 may be a work machine including working equipment, such as an excavator or a bulldozer.

### REFERENCE SIGNS LIST

1 ADMINISTRATION SYSTEM
2 UNMANNED VEHICLE
3 MANAGEMENT DEVICE
3A TRAVEL COURSE DATA GENERATION UNIT
3B STORAGE UNIT
3C COMMUNICATION UNIT
4 COMMUNICATION SYSTEM
5 ADMINISTRATION FACILITY
6 WIRELESS COMMUNICATION DEVICE
7 LOADING MACHINE
8 CRUSHER
10 HYDRAULIC SYSTEM
11 HYDRAULIC PUMP
12 VALVE DEVICE
13 STEERING CYLINDER (FIRST HYDRAULIC ACTUATOR)
13B BOTTOM CHAMBER
13H HEAD CHAMBER
13L STEERING CYLINDER
13R STEERING CYLINDER
14 HOIST CYLINDER (SECOND HYDRAULIC ACTUATOR)
15 HYDRAULIC OIL TANK
16 HYDRAULIC CIRCUIT
16A FLOW PATH
16B FLOW PATH
16Bb FLOW PATH
16Bh FLOW PATH
16C FLOW PATH
16D FLOW PATH
17 TEMPERATURE SENSOR
17A TEMPERATURE SENSOR
17B TEMPERATURE SENSOR
18 STEERING ANGLE SENSOR
21 TRAVELING DEVICE
22 VEHICLE MAIN BODY
23 DUMP BODY
24 DRIVING DEVICE
25 BRAKING DEVICE
26 STEERING DEVICE
27 WHEEL
27F FRONT WHEEL
27R REAR WHEEL
28 POSITION DETECTION DEVICE
29 WIRELESS COMMUNICATION DEVICE
30 CONTROL DEVICE
31 COMMUNICATION UNIT
32 TRAVEL COURSE DATA ACQUISITION UNIT
33 DETECTED STEERING ANGLE ACQUISITION UNIT
34 DETECTED STEERING SPEED CALCULATION UNIT
35 TARGET STEERING ANGLE CALCULATION UNIT
36 RESPONSE CALCULATION UNIT
37 DETERMINATION UNIT
38 RESTRICTION COMMAND UNIT
40 STORAGE UNIT
41 TRAVEL COMMAND UNIT
42 STEERING COMMAND UNIT
C_{R} TRAVEL COURSE
C_{S} TRAVEL TRACK
D_{R} TARGET TRAVEL DIRECTION
V_{R} TARGET TRAVEL SPEED

1. An unmanned vehicle control system comprising:
a travel command unit that outputs a travel command for controlling a travel speed of an unmanned vehicle;
a steering command unit that outputs a steering command for controlling a steering device of the unmanned vehicle;
a response calculation unit that calculates a steering response of the steering device based on a target value of the steering device and a detected value of the steering device detected during a travel of the unmanned vehicle;
a determination unit that determines whether the steering response satisfies a restrictive condition; and
a restriction command unit that outputs a restriction command for restricting the travel speed when the steering response satisfies the restrictive condition.

2. The unmanned vehicle control system according to claim 1, comprising
a travel course data acquisition unit that acquires travel course data including a target travel speed and a target travel direction of the unmanned vehicle,
wherein the travel command unit outputs the travel command based on the target travel speed, and
when the restriction command is output, the travel command unit outputs the travel command such that the travel speed of the unmanned vehicle becomes a restricted travel speed lower than the target travel speed.

3. The unmanned vehicle control system according to claim 2,
wherein, when the restriction command is output, the travel command unit outputs the travel command so as to decelerate from the target travel speed to the restricted travel speed at a constant deceleration.

4. The unmanned vehicle control system according to claim 2,
wherein the target value includes a target steering angle,
the detected value includes a detected steering angle,
the system comprises a target steering angle calculation unit that calculates the target steering angle based on the target travel direction,
the steering command unit outputs a steering command such that the steering device has the target steering angle, and
the response calculation unit calculates the steering response based on the target steering angle and the detected steering angle when the steering command is output at a maximum value from the steering command unit.

5. The unmanned vehicle control system according to claim 1,
wherein the restrictive condition includes one or both of a condition that a difference between the target value and the detected value is a first threshold or more, and a condition that the detected value of the steering device detected during the travel of the unmanned vehicle is a second threshold or less.

6. The unmanned vehicle control system according to claim 1,
wherein the determination unit determines whether the steering response satisfies a cancel condition, and
the restriction command unit cancels the restriction command when the steering response satisfies the cancel condition.

7. The unmanned vehicle control system according to claim 6,
wherein the cancel condition includes a condition that the difference between the target value and the detected value is less than the first threshold.

8. An unmanned vehicle control method comprising:
calculating a steering response of a steering device of an unmanned vehicle based on a target value of the steering device and a detected value of the steering device detected during a travel of the unmanned vehicle; and
restricting a travel speed of the unmanned vehicle when the steering response satisfies a restrictive condition.
